(19) United States
(12) Patent Application Publication
(10) Pub. No.: US 2026/0149995 A1
(43) Pub. Date: May 28, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: ICHIRO TAMURA, Kanagawa (JP)

(21) Appl. No.: 19/381,841

(22) Filed: Nov. 6, 2025

(30) Foreign Application Priority Data
Nov. 27, 2024 (JP) 2024-205983

(51) Int. Cl. H04W 24/10; H04W 8/00

(52) U.S. Cl. CPC H04W 24/10; H04W 8/005

(57) ABSTRACT

A communication apparatus executes first monitoring processing for receiving an announcement signal transmitted by another communication apparatus, second monitoring processing in a case where a connection destination access point (AP) is selected from among one or more APs detected in the first monitoring processing, and controls a monitoring time during which monitoring continues in one channel in monitoring processing, wherein a first monitoring time in the first monitoring processing is shorter than a second monitoring time in the second monitoring processing.

### BACKGROUND

### Field of the Technology

The present disclosure relates to a communication apparatus that performs wireless communication, a control method, and a storage medium.

### Description of the Related Art

The Institute of Electrical and Electronics Engineers (IEEE) 802.11 standards are known as communication standards related to wireless local area networks (WLANs). In the IEEE 802.11 standards, regulations are stipulated related to communications using frequency bands, such as a 2.4 gigahertz (GHz) frequency band, a 5 GHz frequency band, and a 6 GHz frequency band.

United States Patent Application Publication No. 2020/0068486 describes a mechanism in which a specific set of non-unitary and non-contiguous channels from among 6 GHz channels is used as channels recommended for scanning. The search technique described in United States Patent Application Publication No. 2020/0068486 can shorten a scanning time even in a wide frequency band by intentionally narrowing down the channels recommended for scanning.

In the IEEE 802.11ax standards, the concept of preferred scanning channels (PSC) is discussed that handles a set of specific channels from among a plurality of channels in the 6 GHz frequency band as channels recommended for scanning to reduce a scanning time or for other purposes. In the PSC concept, PSCs, which are channels recommended for scanning every 80 megahertz (MHz), are provided. A master unit, such as an access point device that does not start on a PSC channel, may exist. In such a case, a station device needs to scan all channels to detect the counterpart device. There are two type of scanning methods: active scanning and passive scanning. In active scanning, a counterpart device is detected by transmitting a probe request packet and receiving a probe response in response to the probe request packet. In passive scanning, a counterpart device is detected by monitoring announcement signals, such as beacons transmitted at regular intervals by a master unit, such as an access point device. Since announcement signals are transmitted at regular intervals, shortening a monitoring time for continuously performing monitoring processing on each channel shortens the overall time required to scan, but reduces the probability of detecting the counterpart device. Increasing the monitoring time on each channel increases the overall time required to scan, but increases the probability of detecting the counterpart device. Scanning in the 6 GHz frequency band is mainly performed using passive scanning. The 6 GHz frequency band includes a large number of channels, and thus, a setting of the monitoring time per channel may have a significant impact.

### SUMMARY

The present disclosure has been made in view of at least one of the above-described issues. An aspect of the present disclosure is directed to providing a mechanism for setting an appropriate monitoring time in scanning.

According to an aspect of the present disclosure, a communication apparatus includes at least one memory storing a program and at least one processor, that, when executing the program is caused to execute first monitoring processing for receiving an announcement signal transmitted by another communication apparatus, execute second monitoring processing in a case where a connection destination access point (AP) is selected from among one or more APs detected in the first monitoring processing, and control a monitoring time during which monitoring continues in one channel in monitoring processing, wherein a first monitoring time in the first monitoring processing is shorter than a second monitoring time in the second monitoring processing.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a network configuration.

FIG. 2 illustrates an example of a hardware configuration of a communication apparatus.

FIG. 3 illustrates an example of a functional configuration of the communication apparatus.

FIG. 4 is a flowchart illustrating an example of processing for determining a monitoring time by the communication apparatus according to the present disclosure.

FIG. 5 is a sequence diagram illustrating an example of processing for determining a monitoring time by the communication apparatus according to the present disclosure.

### DESCRIPTION OF THE EMBODIMENTS

An embodiment of the present disclosure will be described with reference to the attached drawings. The following embodiment is not limited to the scope of the present disclosure as encompassed by the appended claims. A plurality of features is described in the embodiment, but not all features are necessarily essential to the present disclosure, and the plurality of features may be combined in an arbitrary manner. In the attached drawings, like reference numerals refer to like components, and redundant descriptions will be omitted.

### <Configuration of Communication System>

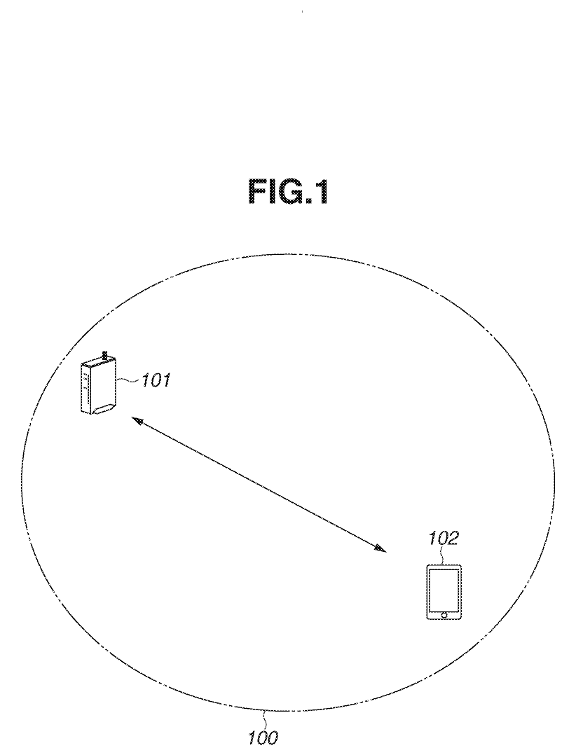

FIG. 1 illustrates a configuration of a wireless network 100 in which a communication apparatus 102 (hereinafter, also referred to as a station (STA) 102) participates according to the present embodiment. A communication apparatus 101 (hereinafter, also referred to as an (access point) AP 101) establishes the wireless network 100. The AP 101 can communicate with the STA 102, and functions as an access point device (a master unit or a base station). The STA 102 is a station device (a subordinate unit or a terminal). According to the present embodiment, in a case where it is unnecessary to distinguish between the AP 101 and the STA 102, those devices may be collectively referred to as communication apparatuses.

The AP 101 and the STA 102 can each perform wireless communication in compliance with the Institute of Electrical and Electronics Engineers (IEEE) 802.11ax/be/bn standards. The AP 101 and the STA 102 can perform communication in a 2.4 gigahertz (GHz) frequency band, a 5 GHz frequency band, and a 6 GHz frequency band. The corresponding frequency band used by each communication apparatus is not limited to these frequency bands, and a different frequency band, such as a 60 GHz frequency band, can be used. The AP 101 and the STA 102 can perform communication using bandwidths of 20 megahertz (MHz), 40 MHz, 80 MHz, 160 MHz, and 320 MHz. The bandwidth used by each communication apparatus is not limited to these, and different bandwidths, such as 240 MHz and 4 MHz can be used.

Specific examples of the AP 101 include, but not limited to, a WLAN router and a personal computer (PC). The AP 101 can be a software access point, a printing apparatus, a digital still camera, a projector, or any type of device that operates as a mobile access point. Specific examples of the STA 102 include, but are not limited to, a digital still camera, a tablet, a smartphone, a PC, a mobile phone, a video camera, and a headset. The STA 102 can be an information processing apparatus, such as a wireless chip that can execute wireless communication in compliance with the IEEE 802.11ax/be/bn standards. Each communication apparatus can perform communication using the bandwidths of 20 MHz, 40 MHz, 80 MHz, 160 MHz, and 320 MHz.

### <Apparatus Configuration>

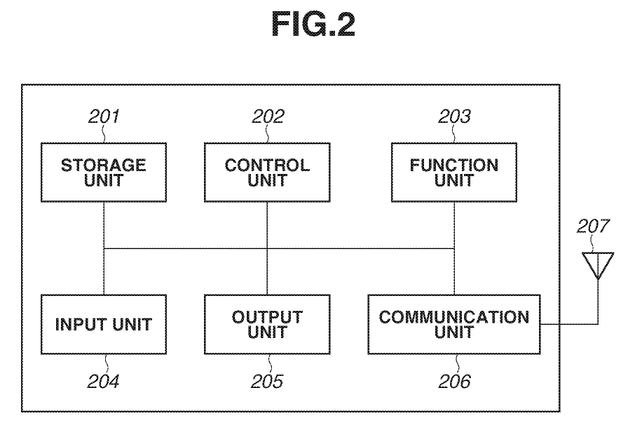

FIG. 2 illustrates an example of a hardware configuration of the communication apparatuses (the AP 101 and the STA 102) according to the present embodiment. The communication apparatuses include a storage unit 201, a control unit 202, a function unit 203, an input unit 204, an output unit 205, a communication unit 206, and an antenna 207. A plurality of antennas 207 can be provided.

The storage unit 201, which includes one or more memories, such as a read only memory (ROM) and/or a random access memory (RAM), and a non-volatile storage, stores computer programs for performing various operations, described below, and various kinds of information, such as communication parameters for wireless communication. The non-volatile storage is a storage, such as a hard disk, a non-volatile memory card, or a solid state drive (SSD).

The control unit 202, which includes one or more processors such as a central processing unit (CPU) and/or a micro processing unit (MPU), controls the AP 101 by executing the computer programs stored in the storage unit 201. The control unit 202 may control the AP 101 using the computer programs stored in the storage unit 201 in cooperation with an operating system (OS). The control unit 202 generates data and signals (wireless frames) transmitted in communications with another communication apparatus. The control unit 202 may include a plurality of processors, such as multi-core processors.

The control unit 202 controls the function unit 203 to perform wireless communication and predetermined pieces of processing, such as imaging, printing, and projecting. The function unit 203 is hardware for the AP 101 uses to execute predetermined processing.

The input unit 204 receives various operations from a user. The output unit 205 outputs various types of information to the user by, for example, displaying visual output on a monitor screen, audio output via a speaker, or vibration output. The input unit 204 and the output unit 205 may be integrated as a single component, such as a touch panel. The input unit 204 and the output unit 205 may be integrated with the communication apparatus or provided separate from the communication apparatus.

The communication unit 206 may control wireless communication in compliance with the IEEE 802.11ax/be/bn standards, the IEEE 802.11 (IEEE 802.11a/b/g/n/ac) standard series, and wired communication, such as a wired LAN. The communication unit 206 controls the antenna 207 to transmit and receive signals generated by the control unit 202 for wireless communication.

In a case where the communication apparatus supports near-field communication (NFC) standards, Bluetooth® standards, and other standards, as well as the IEEE 802.11ax/be/bn standards, the communication unit 206 may control wireless communication in compliance with those communication standards. In a case where the AP 101 can execute wireless communication in compliance with a plurality of communication standards, the AP 101 may have a configuration in which a communication unit and an antenna corresponding to each communication standard are provided individually. One communication apparatus exchanges data, such as image data, document data, and video data, with the other communication apparatus via the communication unit 206. The antenna 207 may be configured as a single component separate from the communication unit 206 or may be integrated with the communication unit 206.

The antenna 207 can perform communication in the 2.4 GHz frequency band, the 5 GHz frequency band, and the 6 GHz frequency band. According to the present embodiment, each communication apparatus includes a single antenna, or may include a different antenna for each frequency band. Where each communication apparatus includes a plurality of antennas, the communication apparatus may include the communication unit 206 corresponding to each antenna.

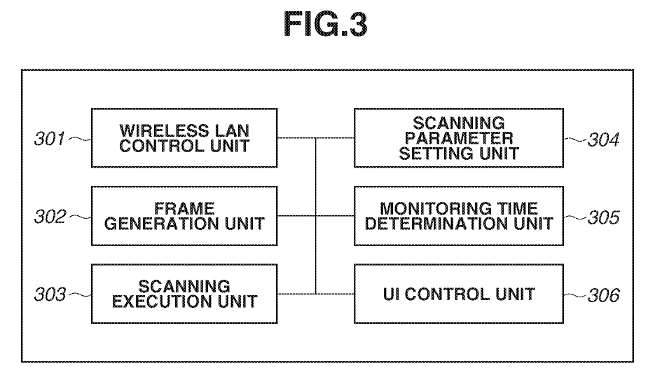

FIG. 3 is a block diagram illustrating a functional configuration of the communication apparatuses (the AP 101 and the STA 102) according to the present embodiment. Each communication apparatus herein includes a WLAN control unit 301, where the number of WLANs can be one or more. The communication apparatus also includes a frame generation unit 302, a scanning execution unit 303, a scanning parameter setting unit 304, a monitoring time determination unit 305, and a user interface (UI) control unit 306. These functional components can be implemented, for example, by one or more processors included in the control unit 202 executing programs stored in one or more memories included in the storage unit 201. Dedicated hardware components may be mounted as some or all of these functional components.

The WLAN control unit 301 includes an antenna and a circuit for transmitting and receiving wireless signals to and from another WLAN device, and a program for controlling the antenna and the circuit. The WLAN control unit 301 executes WLAN communication control based on frames generated by the frame generation unit 302 in accordance with the IEEE 802.11 standard series.

The frame generation unit 302 generates wireless control frames transmitted by the WLAN control unit 301. The frame generation unit 302 may generate a probe request required for active scanning. Information about the generated frame is transmitted to the WLAN control unit 301for transmission to a communication partner.

The scanning execution unit 303 performs scanning based on information in the scanning parameter setting unit 304 and the monitoring time determination unit 305. The scanning execution unit 303 determines whether scanning to be executed is active scanning or passive scanning, and performs processing required for each scanning.

There are two types of scanning methods: active scanning and passive scanning. In active scanning, the scanning execution unit 303 detects an AP by transmitting a probe request packet and receiving a probe response in response to the probe request packet. In passive scanning, the scanning execution unit 303 detects an AP by performing monitoring processing for announcement signals, such as beacons, transmitted by the AP at regular intervals.

The scanning parameter setting unit 304 sets a parameter used at the time of performing scanning. The parameter being set can be, for example, a service set identifier (SSID) or a short SSID, both of which are network identifiers. Setting an SSID at the time of scanning enables searching for an AP having the same SSID in performing roaming processing. The parameter can be, for example, a basic service set identifier (BSSID), which is an AP identifier, and only a specific AP can be searched for by setting the BSSID at the time of scanning.

Other examples of the parameter include, but are not limited to, frequency, encryption method, encryption key, or authentication method.

By not setting any parameters, all communication apparatuses in the vicinity can be searched for.

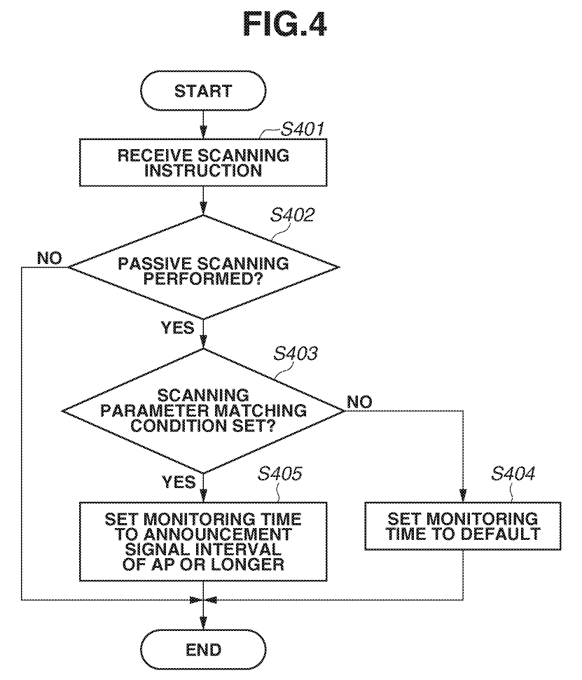

The monitoring time determination unit 305 determines a monitoring time for monitoring announcement signals from an AP in performing passive scanning based on the parameter set by the scanning parameter setting unit 304 according to operations in a flowchart illustrated in FIG. 4. In this case, examples of the announcement signals from an AP may include, but are not limited to, a beacon frame, a probe response frame, a fast initial link setup (FILS) discovery frame, and an unsolicited probe response frame transmitted by the AP. The monitoring time refers to the duration allocated for receiving announcement signals transmitted by the AP in a desired channel, and corresponds to the period during which monitoring is continuously performed on that channel. In other words, the time required for passive scanning is basically the time obtained by multiplying the monitoring time by the number of channels for which monitoring processing is executed.

The UI control unit 306 issues, via the output unit 205, notifications of information about other communication apparatuses, which is a result of scanning performed by the scanning execution unit 303. The UI control unit 306 receives parameter inputs to the scanning parameter setting unit 304 via the input unit 204.

Scan control by the STA 102 will now be described with reference to the flowchart in FIG. 4. The illustrated flowchart is a partially extracted flowchart focusing on scan-related processing for the purpose of describing control related to scanning. Specifically, the flowchart illustrates a series of processing that starts in response to the STA 102 changing a monitoring time for passive scanning based on a setting or settings for a scanning parameter.

The processing illustrated in the flowchart is executed by the one or more processors of the control unit 202 in the STA 102 executing computer programs stored in the storage unit 201. Some of the processing, such as transmission and modulation, is performed by the one or more processors of the control unit 202 in cooperation with various types of processors included in the communication unit 206, an Application Specific Integrated Circuit (ASIC), a digital signal processor (DSP), a field-programmable gate array (FPGA), and the like. Display control and user operation reception control are performed by the one or more processors of the control unit 202 in cooperation with the input unit 204 and the output unit 205. For description purposes, the corresponding functional unit described with reference to FIG. 3 is used as the subject of the processing.

In step S401, the STA 102 receives an instruction to start scanning. Then, in step S402, the STA 102 determines whether to perform passive scanning for scanning processing to be performed.

The determination whether to perform passive scanning may be made based on, for example, whether the STA 102 supports a frequency band that requires passive scanning in accordance with a country’s regulations governing radio communication, i.e., radio law, and/or the setting(s) of the STA 102 itself. The method for determining whether to perform passive scanning is not limited to be limited to these approaches.

If it is determined that passive scanning is not performed (NO in step S402), the processing ends, and processing required for active scanning starts. If it is determined that passive scanning is performed (YES in step S402), in step S403, it is determined whether a scanning parameter that matches a condition for changing the monitoring time is set. If a scanning parameter that matches the condition for changing the monitoring time is not set (NO in step S403), in step S404, the monitoring time is set to the default, the processing then ends, and processing required for scanning starts.

If a scanning parameter that matches the condition for changing the monitoring time is set (YES in step S403), in step S405, the monitoring time is set to a time greater than or equal to a transmission interval of announcement signals (an announcement signal interval) of an AP. The processing then ends, and the processing required for scanning starts. According to the present embodiment, in step S403, it is determined whether a scanning parameter that matches the condition for changing the monitoring time is set, but this is not seen to be limiting. For example, it can be determined whether the user selects a connection destination AP. In this case, if the user selects a connection destination AP (YES in step S403), the processing proceeds to step S405. The scanning parameter that matches the condition for changing the monitoring time is, for example, a parameter that identifies an AP or a network, and may be a parameter that identifies a frequency band or a channel. Specifically, the scanning parameter may be the SSID of a network established by the AP, the BSSID of the AP, the frequency band at which the AP establishes the network, or the like, but is not limited to these. If a scanning parameter that identifies an AP is set, the presence of the AP is already confirmed, and it is considered that the purpose is to connect to a network established by the AP. In such a case, if the AP cannot be detected by scanning at the time of connection processing, a notification of connection failure is issued. Thus, it is important to detect the AP by scanning. To improve an AP detection rate, it is necessary to set the monitoring time greater than or equal to a transmission interval of announcement signals from the AP. The transmission interval of announcement signals from an AP can be set based on 100 milliseconds (ms), which is an interval used by many APs, or can be set based on, if information about a specific AP set in advance is found by prior scanning processing or the like, a transmission interval of announcement signals from the specified AP. A reference value for an announcement signal determined in advance by the STA 102 can be used.

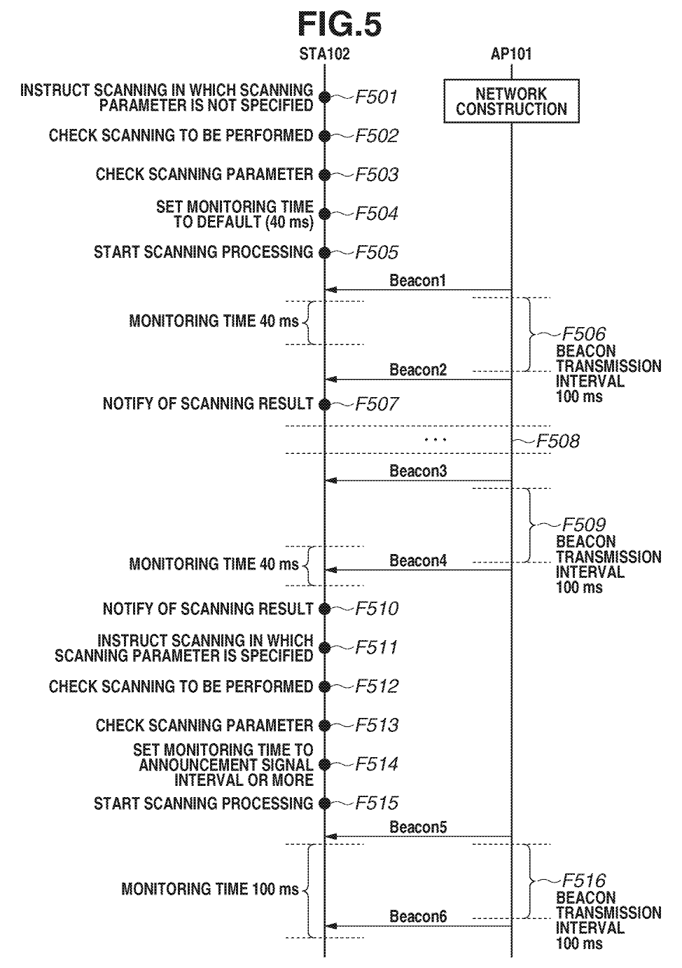

Operations of the AP 101 and the STA 102 according to the present embodiment will now be described with reference to a sequence diagram illustrated in FIG. 5. In FIG. 5, the AP 101 has already established a network. In step F501, the STA 102 receives a scanning instruction from the user via the input unit 204. Here, it is assumed that the scanning parameter is not set in order to scan communication apparatuses in the vicinity. In step F502, the STA 102 that has received the scanning instruction checks whether the scanning to be performed includes passive scanning. According to the present embodiment, the STA 102 is considered to support channels in the 6 GHz frequency band, and checks that passive scanning is to be performed. In step F503, the STA 102 checks whether the scanning parameter is set to change the monitoring time in the scanning instruction received in step F501. In this case, since the scanning parameter is not set in step F501, in step F504, the STA 102 checks that the scanning parameter is not set to change the monitoring time, and the monitoring time is set to the default. According to the present embodiment, the default monitoring time is set to 40 ms. In addition, according to the present embodiment, a transmission interval of beacons, which are announcement signals from the AP 101, is set to 100 ms. In step F506, a monitoring time of the STA 102 of 40 ms is performed within the 100 ms interval between beacons 1 and 2 of the AP 101, which may cause the STA 102 to be unable to detect the AP 101. In step F507, the STA 102 notifies the user of a scanning result in step F506, which does not include the AP 101.

The user, receiving the notification in step F507, re-issues the scanning instruction in step F501 since the scanning result does not include the desired AP 101. In step F508, the STA 102 repeats the processing from step F502 to step F505. Next, in step F509, a beacon 4 from the AP 101 is transmitted during a monitoring time of 40 ms for scanning, so that the STA 102 can detect the AP 101. According to the present embodiment, the monitoring time in the processing in step F509 is always 40 ms. However, the monitoring time can be changed, for example, to extend based on the number of scanning instructions without setting the scanning parameter received from the user within a certain timeframe.

In step F510, the STA 102 notifies the user of the scanning result in step F509, which includes the AP 101. In step F511, the user, who received the notification in step F510, sets a parameter to specify the AP 101 since the scanning result includes the desired AP 101, and then issues a scanning instruction for connection. In step F511, it is assumed that the SSID of the AP 101 is set. However, the BSSID or frequency can be set. According to the present embodiment, to describe the scanning processing by the STA 102, it is assumed that scanning is started in response to the STA 102 receiving a scanning instruction from the user. This is not seen to be limiting. For example, scanning can be started based on an instruction to connect to an AP specified by the user, which requires scanning, or an instruction to carry out another function for connecting to an AP desired by the user.

In step F512, upon receiving the scanning instruction, the STA 102 checks whether the scanning to be performed includes passive scanning. According to the present embodiment, the STA 102 is considered to support channels in the 6 GHz frequency band, and the STA 102 checks that passive scanning is to be performed. Then, in step F513, the STA 102 checks whether the scanning parameter is set to change the monitoring time in the scanning instruction received in step F511. Since the SSID of the AP 101 is set in step F511, in step F514, the STA 102 checks that the scanning parameter is set to change the monitoring time and the monitoring time is set to a time greater than or equal to the announcement signal interval of the AP. According to the present embodiment, it is assumed that the STA 102 sets the monitoring time to 100 ms. The announcement signal interval of the AP 101 can, for example, be used that is found in scanning performed in advance or the longest announcement signal interval in the APs in the scanning result. The set monitoring time of the STA 102 to 100 ms or more covers an announcement signal interval of the AP 101 of 100 ms, so that the STA 102 can receive an announcement signal from the AP 101 even if performing monitoring at any timing. In step F516, a beacon 6 from the AP 101 can be received during the monitoring period, and thus, the STA 102 can detect the AP 101.

As described above, when the user instructs scanning with a parameter set that specifies an AP, a monitoring time for the scanning is set to an interval greater than or equal to a transmission interval of announcement signals from the AP (for example, 100 ms). This enables improving a scanning success rate and reducing the possibility of notifying the user that connection processing is unsuccessful. When a user instructs scanning without setting a parameter that specifies an AP, a quick response can be made to the user, providing a scanning result by shortening the monitoring time (for example, 100 ms or less).

According to the above-described embodiment, a user’s instruction is required in a case where scanning is performed again after communication apparatuses are scanned in the vicinity. This is not seen to be limiting. For example, in a case where a scanning instruction is received in step F501, scanning can be repeated until an instruction to connect to an AP is received from the user. In this case, the monitoring time can be extended based on scanning being automatically repeated. The monitoring time can be extended based on the fact that a predetermined time has elapsed since the start of scanning.

According to the above-described embodiment, a monitoring time is extended when a scanning parameter that matches a condition for changing the monitoring time is set. This is not seen to be limiting. The monitoring time can be shortened when the scanning parameter that matches the condition for changing the monitoring time is not set. In this case, the monitoring time when the scanning parameter that matches the condition for changing the monitoring time is not set can be set as the default. When the monitoring time is shortened in this manner, the monitoring time can be changed based on the frequency band in which monitoring is executed. For example, the monitoring time for a 6 GHz frequency band channel can be 40 ms, the monitoring time for a 5 GHz frequency band channel can be 50 ms, and the monitoring time for a 2.4 GHz frequency band channel can be 60 ms. Only the monitoring time for the 6 GHz frequency band channel can be shortened.

According to an aspect of the present disclosure, an appropriate monitoring time can be set at the time of scanning.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205983, filed Nov. 27, 2024, which is hereby incorporated by reference herein in its entirety.

What is claimed is:

1. A communication apparatus comprising:
at least one memory storing a program; and
at least one processor, that, when executing the program is caused to:
execute first monitoring processing for receiving an announcement signal transmitted by another communication apparatus;
execute second monitoring processing in a case where a connection destination access point (AP) is selected from among one or more APs detected in the first monitoring processing; and
control a monitoring time during which monitoring continues in one channel in monitoring processing,
wherein a first monitoring time in the first monitoring processing is shorter than a second monitoring time in the second monitoring processing.

2. The communication apparatus according to claim 1, wherein the at least one processor is further caused to receive users instruction to select the connection destination AP from among the one or more detected APs.

3. The communication apparatus according to claim 1, wherein the at least one processor is further caused to display the one or more detected APs.

4. The communication apparatus according to claim 1, wherein the connection destination AP is selected in a case where one or more of a service set identifier (SSID), a short SSID, a basic SSID (BSSID), or a frequency of a network established by the AP are set.

5. The communication apparatus according to claim 1, wherein the monitoring processing is passive scanning that receives the announcement signal transmitted by the AP.

6. The communication apparatus according to claim 1, wherein the announcement signal is a beacon frame, a probe response frame, a fast initial link setup (FILS) discovery frame, or an unsolicited probe response frame.

7. The communication apparatus according to claim 1, wherein the second monitoring time is greater than or equal to 100 milliseconds (ms).

8. The communication apparatus according to claim 1, wherein the at least one processor is further caused to, in a case where a channel of a first frequency band and a channel of a second frequency band are monitored in the first monitoring processing, perform control so that the monitoring time in the channel of the first frequency band is shorter than the monitoring time in the channel of the second frequency band.

9. The communication apparatus according to claim 8, wherein the first frequency band is a 6 gigahertz (GHz) frequency band.

10. A method for controlling a communication apparatus, the method comprising:
executing first monitoring processing for receiving an announcement signal transmitted by another communication apparatus;
executing second monitoring processing in a case where a connection destination AP is selected from among one or more APs detected in the first monitoring processing; and
controlling a monitoring time during which monitoring continues in one channel in monitoring processing,
wherein a first monitoring time in the first monitoring processing is shorter than a second monitoring time in the second monitoring processing.

11. A non-transitory computer-readable storage medium storing instructions that, when executed by a computer, cause the computer to perform a method for controlling a communication apparatus, the method comprising:
executing first monitoring processing for receiving an announcement signal transmitted by another communication apparatus;
executing second monitoring processing in a case where a connection destination AP is selected from among one or more APs detected in the first monitoring processing; and
controlling a monitoring time during which monitoring continues in one channel in monitoring processing,
wherein a first monitoring time in the first monitoring processing is shorter than a second monitoring time in the second monitoring processing.
